(19) United States
(12) Patent Application Publication
(10) Pub. No.: US 2010/0062335 A1
(43) Pub. Date: Mar. 11, 2010

(54) BIPOLAR BATTERY

(75) Inventor: Ajoy Datta, Fullerton, CA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: LUMINOUS POWER TECHNOLOGIES PVT LTD, New Delhi (IN)

(21) Appl. No.: 12/515,189

(22) PCT Filed: Nov. 7, 2007
(86) PCT No.: PCT/IN07/00525

§ 371 Date: Nov. 16, 2009

(30) Foreign Application Priority Data
Nov. 15, 2006 (IN) 2463/DEL/2006

(51) Int. Cl. H01M 10/18

(52) U.S. Cl. 429/210

(57) ABSTRACT

Bipolar plates for a lead acid battery and bipolar plate stack assembly comprising such plates is described. In another aspect, the subject matter describes, a lead acid battery comprising such bipolar plate stack assembly.

### TECHNICAL FIELD

This invention in general relates to lead acid batteries and in particular relates to bipolar lead acid batteries, and to bipolar plates for use in bipolar lead acid batteries.

### BACKGROUND

A lead-acid battery is a secondary electrochemical device that stores energy and makes it available in an electrical form. Lead acid batteries are the most widely used secondary batteries, extensively employed in applications like automobiles. The lead acid battery may comprise of several cells connected in parallel or series.

The basic construction of the cell comprises a positive electrode, a negative electrode, and an electrolyte which is dilute sulphuric acid. The positive electrode and the negative electrode are also referred to as the positive and negative plates respectively. A paste, generally comprising lead oxide, lead sulphate, water and certain other additives, taken in a fixed proportion, is applied to a grid to form a plate. Electrical connections are provided between grids acting as positive and negative plates.

In conventional battery designs, the use of single inter cell electrical connection between adjacent cells restricts cell-to-cell current flow. Single inter cell electrical connections contribute to higher internal resistance of a battery and have an adverse impact on high power discharge performance and rapid recharge capabilities of the battery. Further, single inter cell connections are prone to mechanical failure, affecting battery robustness and operational safety.

Another fundamental limitation of conventional a single inter cell connection is non uniform current density over the plate geometry. Due to the non uniform current distribution, the portion of the grid closest to the connector corrodes more compared to the portions further away from the connector.

A bipolar plate construction helps to overcome the drawbacks of the conventional battery having single inter cell electrical connection between adjacent cells. A bipolar plate, also called a biplate, consists of a thin, electrically conducting sheet having negative active material applied to one side of its flat surface and positive material applied to the other side. The bipolar battery structure typically has a “stack” that employs a sequence of elements, including a negative monopolar terminal plate, a separator, a repeating sequence of bipolar plates and separators, and a positive monopolar terminal plate. Electrical termination is achieved via the monopolar terminal plates.

Since the electrical path between the positive and negative active materials of adjacent cells is extremely short i.e., due the small thickness of the biplate, the resistance is typically very small.

A conventional bipolar plate uses a lead substrate which is pasted with positive paste on one surface and negative paste on the opposite surface. One of the primary problems associated with such bipolar plate constructions is premature failure due to corrosion through the lead substrate resulting in cell to cell short circuits. Another common, life limiting issue is the poor adherence of the paste material to the flat surfaces of the lead substrate, resulting in eventual loss of contact between the active material and grid. There thus exists a need for bipolar plates with corrosion resistant substrates and of robust construction.

### SUMMARY

This summary is provided to introduce a selection of concepts in a simplified form that are further described below in the detailed description. This summary is not intended to identify essential features of the claimed subject matter, nor is it intended for use in determining the scope of the claimed subject matter.

In an embodiment of the subject matter, a bipolar plate for a lead acid battery is described. The bipolar plate comprises a grid having a first predetermined dimension, a spacer having a second predetermined dimension, a positive paste, a negative paste, a positive conducting surface, and a negative conducting surface. The grid is folded over the spacer such that the grid substantially covers both sides of the spacer. The positive conductive surface is formed by pasting the positive paste on one side of the grid, and the negative surface is formed by pasting the negative paste on other side of the grid.

Another embodiment of the subject matter describes a bipolar plate comprising a first grid having a first predetermined dimension, a second grid also having the first predetermined dimension, a spacer having a second predetermined dimension, a positive paste, a negative paste, a positive conducting surface, and a negative conducting surface is described. The first grid and the second grid are placed on either side of the spacer and connected along the edges of the first grid and the second grid such that the spacer is within the edges of the first and the second grid. The positive conductive surface is formed by pasting the positive paste over first grid and the negative surface is formed by pasting the negative paste over the second grid.

In another embodiment, a bipolar plate stack assembly is described. The bipolar plate stack assembly comprises a positive monopolar terminal plate, a negative monopolar terminal plate and a plurality of bipolar plates of the previous embodiments. The bipolar plates are stacked with a separator placed between adjacent bipolar plates. The positive monopolar terminal plate and the negative monopolar terminal plate are placed at the two ends of the plurality of bipolar plates with a separator between the monopolar terminal plate and the next bipolar plate.

In yet another embodiment a lead acid battery is described. The lead acid battery comprises a battery container having a positive terminal and a negative terminal, and one or more bipolar plate assembly of the preceding embodiments. The positive monopolar terminal plate of each bipolar plate assembly is electrically connected to the positive terminal and negative monopolar terminal plate of each bipolar plate assembly is electrically connected to the negative terminal.

### BRIEF DESCRIPTION OF THE DRAWINGS

FIG. 1 provides an illustration of a grid 100.

FIGS. 2A and 2B provide an illustration of a method of folding the grid of FIG. 1 over a spacer in accordance with one embodiment of the invention.

FIG. 2C illustrates a bipolar grid formed by the method of folding of FIGS. 2A and 2B.

FIG. 3A provides an illustration of a method of construction of a bipolar grid in accordance with an embodiment of the invention.

FIG. 3B illustrates a bipolar grid formed by the method of construction of FIG. 3A.

FIG. 4A provides an illustration of a method of folding the grid of FIG. 1 over a spacer in accordance with one embodiment of the invention.

FIG. 4B illustrates a bipolar grid formed by the method of folding of FIG. 4A.

FIG. 5A provides an illustration of a method of folding the grid of FIG. 1 over a spacer in accordance with one embodiment of the invention.

FIG. 5B illustrates a bipolar grid formed by the method of folding of FIG. 5A.

FIG. 6 provides an illustration of a bipolar plate formed by pasting a bipolar grid of FIG. 2C, FIG. 3B, FIG. 4B or FIG. 5B.

FIG. 7 provides an illustration bipolar plate stack assembly comprising the bipolar plates of FIG. 6.

FIG. 8 provides an illustration of a lead acid battery comprising one or more bipolar plate stack assembly of FIG. 7.

FIG. 8A provides an illustration a top view of a lead acid battery comprising one or more bipolar plate stack assembly of FIG. 7.

### DETAILED DESCRIPTION

In one embodiment of the subject matter a bipolar plate comprising a grid having a predetermined dimension, a spacer having a second predetermined dimension, a positive paste, a negative paste, a positive conducting surface, and a negative conducting surface is described. The grid is folded over the spacer such that the grid substantially covers both sides of the spacer. The positive conductive surface is formed by pasting the positive paste on one side of the grid 100, and the negative surface is formed by pasting the negative paste on other side of the grid.

In another embodiment of the subject matter a bipolar plate stack assembly comprising a positive monopolar terminal plate, a negative monopolar terminal plate, a plurality of separators and a plurality of bipolar plates is described. The bipolar plate comprises a grid having a first predetermined dimension, a spacer having a second predetermined dimension, a positive paste, a negative paste, a positive conducting surface, and a negative conducting surface wherein the grid is folded over the spacer such that the grid substantially covers both sides of the spacer. The positive conductive surface is formed by pasting the positive paste on one side of the grid and the negative surface is formed by pasting the negative paste on the other side of the grid. The plurality of bipolar plates are stacked with a separator placed between adjacent bipolar plates, and the positive monopolar terminal plate and the negative monopolar terminal plate are placed at the two ends of the plurality of bipolar plates with a separator between monopolar terminal plate and adjacent bipolar plate.

In another embodiment of the subject matter a bipolar plate comprising a first grid having a first predetermined dimension, a second grid having the first predetermined dimension, a spacer having a second predetermined dimension, a positive paste, a negative paste, a positive conducting surface, and a negative conducting surface is described. The first grid and the second grid are placed on either side of the spacer and connected along the edges of the first grid and the second grid such that the spacer is within the first grid and the second grid and the positive conductive surface is formed by pasting the positive paste over first grid and the negative surface is formed by pasting the negative paste over the second grid.

In one embodiment of the subject matter, in the bipolar plate of the previous embodiment, the first grid and the second grid are made of different materials.

In yet another embodiment of the subject matter a bipolar plate stack assembly comprising a positive monopolar terminal plate, a negative monopolar terminal plate, a plurality of separators, and a plurality of bipolar plates is described. Each bipolar plate comprises a first grid having a first predetermined dimension, a second grid having the first predetermined dimension, a spacer having a second predetermined dimension, a positive paste, a negative paste, a positive conducting surface, and a negative conducting surface. The first grid and the second grid are placed on either side of the spacer and connected along the edges of the first and the second grid such that the spacer is within the edges of the first and the second grid. The positive conductive surface is formed by pasting the positive paste over first grid and the negative surface is formed by pasting the negative paste over the second grid. The plurality of bipolar plates are stacked with a separator placed between adjacent bipolar plates, and the positive monopolar terminal plate and the negative monopolar terminal plate are placed at the two ends of the plurality of bipolar plates with a separator between monopolar terminal plate and adjacent bipolar plate.

In another embodiment of the subject matter, in the bipolar plate of the previous embodiments the grid is a wire mesh.

In one embodiment of the subject matter, in the bipolar plate of the previous embodiments the grid is made of a metallic material alloy.

In yet another embodiment of the subject matter, a lead acid battery comprising the bipolar plate of the previous embodiments is described.

In one embodiment of the subject matter, a lead acid battery comprising a battery container having a positive terminal and a negative terminal, and one or more bipolar plate stack assembly of the previous embodiment is described. The positive monopolar terminal plate of each bipolar plate stack assembly is electrically connected to the positive terminal and negative monopolar terminal plate of each bipolar plate stack assembly is electrically connected to the negative terminal.

Aspects of the bipolar plate, bipolar stack assembly and lead acid battery described herein can he implemented in any number of different environments, and/or configurations that will be obvious to a person skilled in the art. Different embodiments of the battery are herein described in the context of the following exemplary method(s) only as examples and are not limiting to the scope of the described subject matter.

### EXAMPLE 1

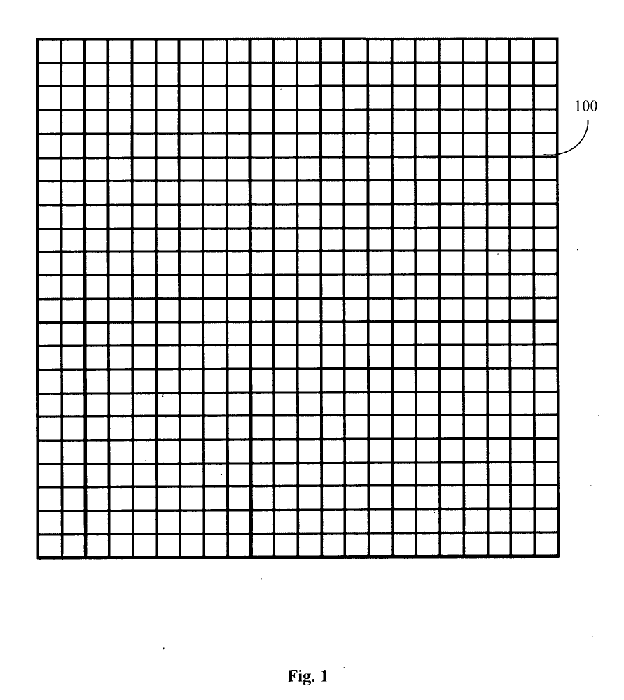

FIG. 1 provides an illustration of a grid 100.

The grid 100 is a wire mesh made of metallic material or alloy. The grid 100 is typically made of metallic lead or a lead-based alloy. The grid 100 is made by conventional techniques such as direct casting, stamping, forging or by mechanical working.

### EXAMPLE 2

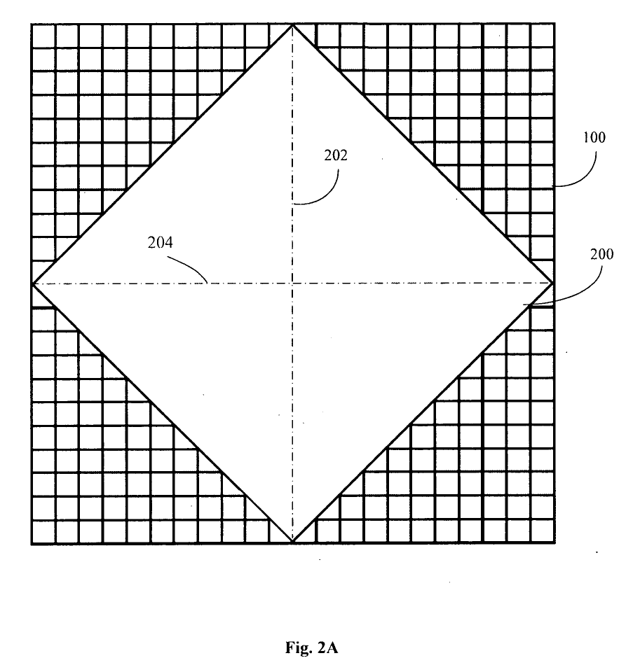

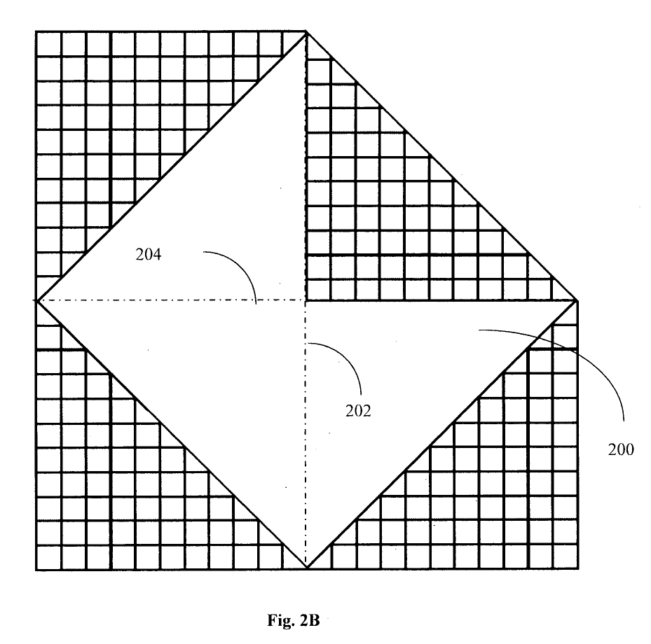

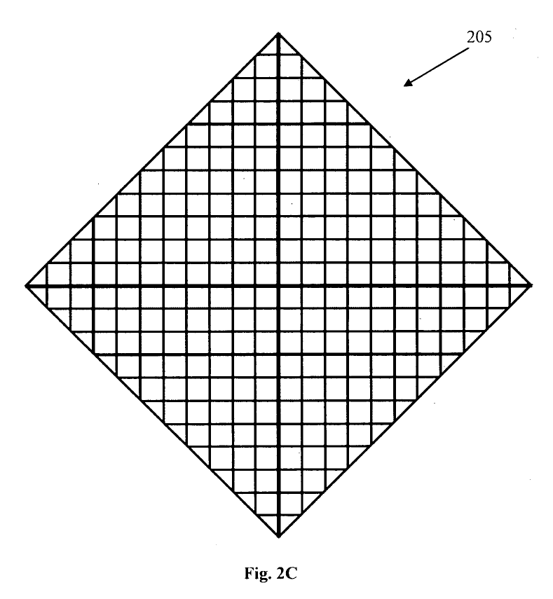

FIGS. 2A and 2B provide an illustration of a method of folding the grid of FIG. 1 over a spacer in accordance with one embodiment of the invention.

FIG. 2A shows a spacer 200 placed on the grid 100. The spacer 200 is a planar sheet of a non conductive material substantially half the size of the grid 100. The shape and size of the grid 100 and spacer 200 are chosen such that the grid 100, when folded over the spacer 200, covers a significant part of the spacer 200. In the present example the smaller sized spacer 200 is placed over the larger sized grid 100 such that two diagonals 202 and 204 of the spacer are substantially along the vertical and horizontal centerlines of the grid respectively. The bottom surface of the spacer 200 is in contact with the grid 100.

FIG. 2B provides an illustration of the grid 100 folded over the spacer 200. The sides of the grid 100 extending beyond the spacer 200 are folded inwards so as to cover the top surface of the spacer 200 along the two diagonals 202 and 204.

FIG. 2C illustrates a bipolar grid 205 formed by the method of folding of FIG. 2A and 2B.

### EXAMPLE 3

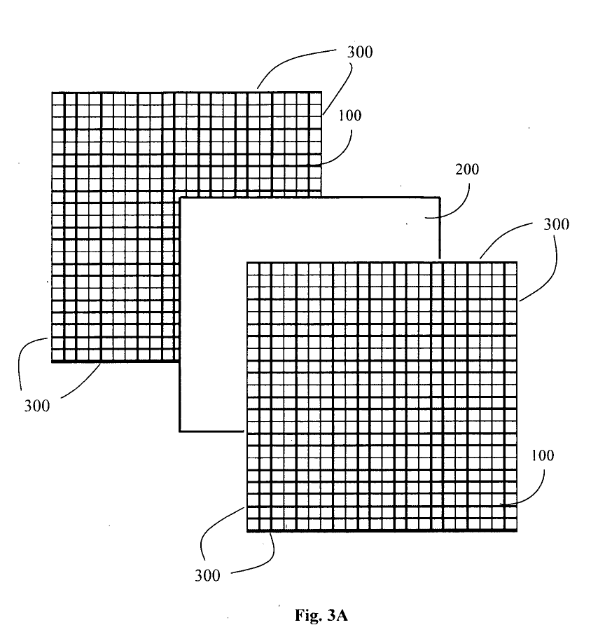

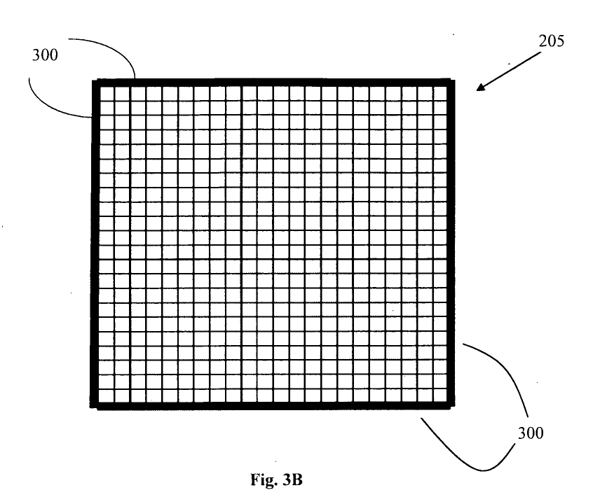

FIG. 3A provides an illustration of a method of construction of a bipolar grid in accordance with an embodiment of the invention.

As depicted in FIG. 3A a first grid 100 having a first predetermined dimension, a second grid 100 having the first predetermined dimension, and a spacer 200 having a second predetermined dimension. The first grid 100 and the second grid 100 are placed on either side of the spacer 200 and connected along the edges 300 of the first grid and the second grid such that the spacer 200 is within the edges 300 of the first grid 100 and the second grid 100.

FIG. 3B illustrates a bipolar grid 205 connected along the edges 300, formed by the method of construction of FIG. 3A.

### EXAMPLE 4

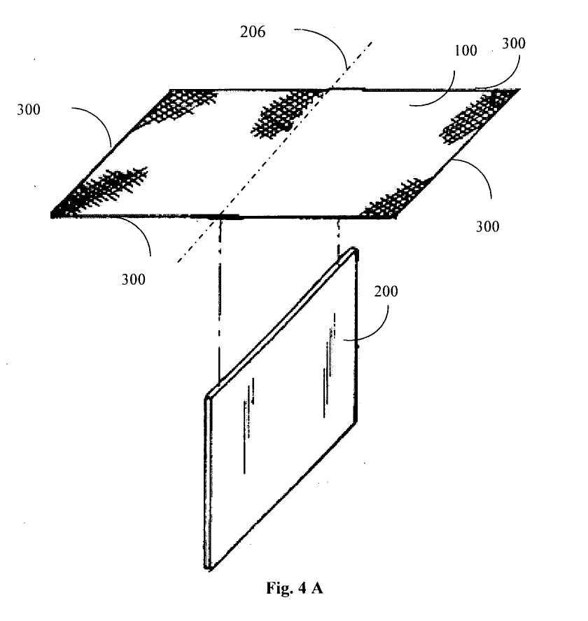

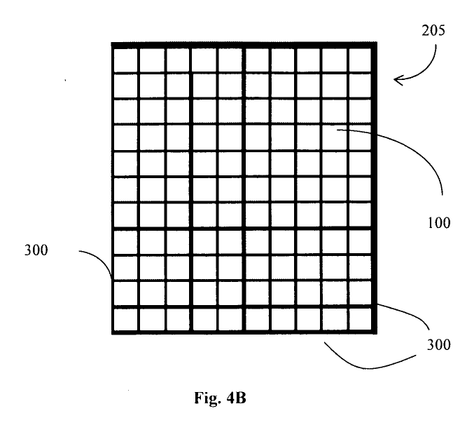

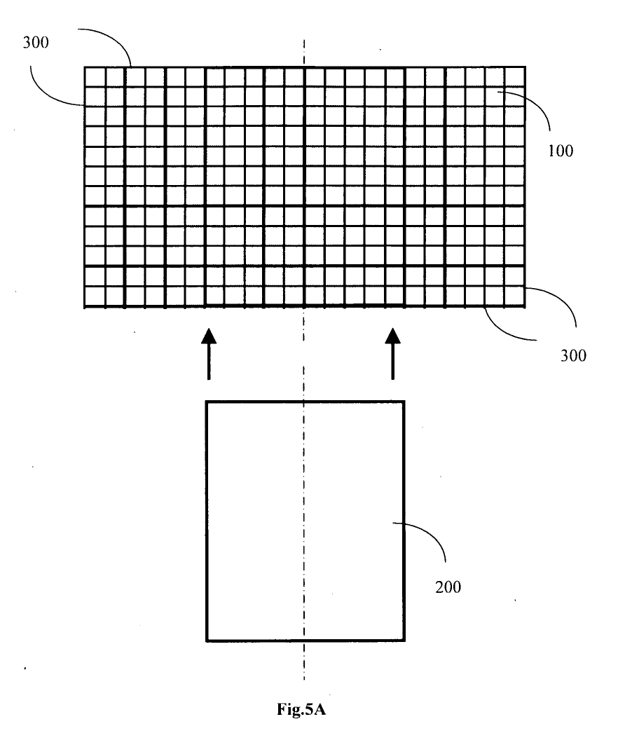

FIG. 4A provides an illustration of a method of folding the grid 100 of FIG. 1 over a spacer in accordance with one embodiment of the invention. The grid 100 has edges 300

As shown in FIG. 4A the grid 100 and spacer 200 have substantially the same breadth while the length of the grid 100 is about twice that of the spacer 200. The grid 100 is folded along a center line 206 along its length on either side of the spacer 200 in between

FIG. 4B illustrates a bipolar grid 205 formed by the method of folding of FIG. 4A. The figure depicts the grid 100 connected along three of the edges 300 such that the spacer 200 is within the grid 100.

### EXAMPLE 5

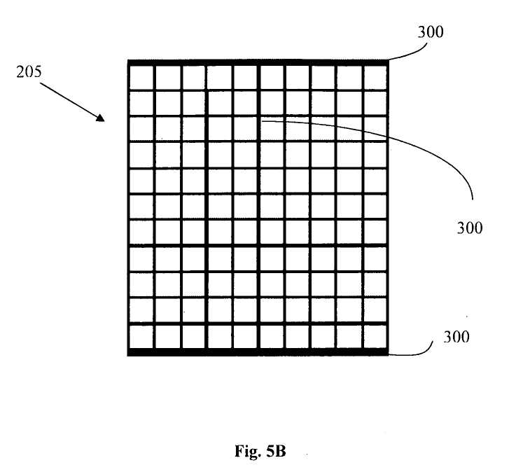

FIG. 5A provides an illustration of a method of folding the grid of FIG. 1 over a spacer in accordance with one embodiment of the invention.

As shown in FIG. 5A the grid 100 with edges 300 and spacer 200 have substantially the same breadth while the length of the grid 100 is about twice that of the spacer 100. The spacer 200 is placed on the grid 100 such that the centre line drawn of the spacer 200 substantially coincides with a central line of the grid 100. The bottom surface of the spacer 200 touches the grid 100. The portion of the grid 100 extending beyond the spacer on two sides is folded inwards to substantially cover the top surface of the spacer 200.

FIG. 5B illustrates a bipolar grid 205 formed by the method of folding of FIG. 5A. The folded grid 100 is connected along two edges 300 such that the spacer 200 is within the grid 100.

### EXAMPLE 6

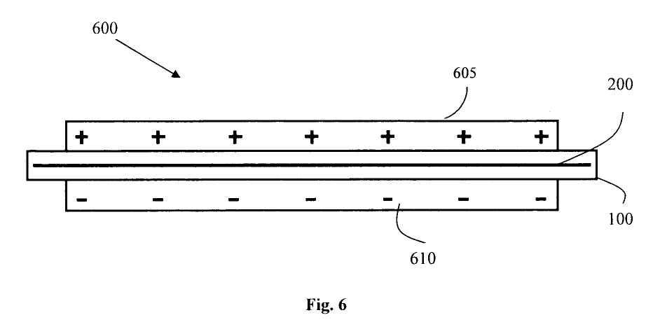

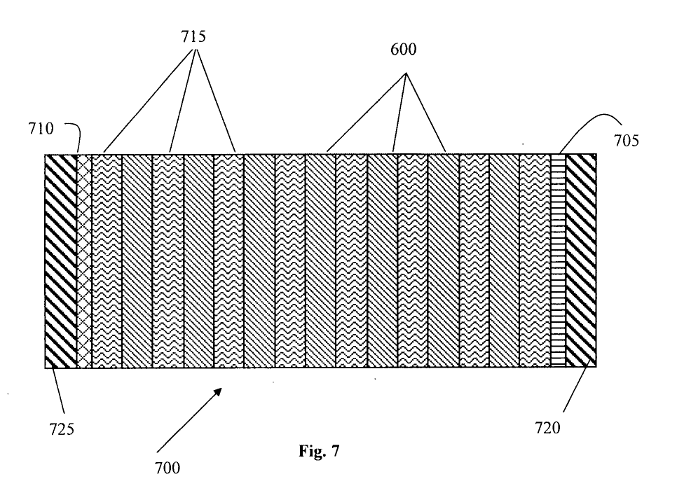

FIG. 6 provides an illustration of a bipolar plate 600 comprises the bipolar grids of FIG. 2C, FIG. 3B, FIG. 4B or FIG. 5B.

The bipolar plate 600 comprises a grid 100, a spacer 200, a positive paste, a negative paste; a positive conducting surface 605; and a negative conducting surface 610 wherein the grid 100 is folded over said spacer 200 such that said grid 100 covers substantially both sides of said spacer 200. Said positive conductive surface 605 is formed by pasting said positive paste on one side of said grid 100, and said negative surface 610 is formed by pasting said negative paste on other side of said grid 100.

### EXAMPLE 7

FIG. 7 provides an illustration bipolar plate stack assembly 700 comprising bipolar plates of FIG. 6.

The bipolar plate stack assembly 700 comprises a positive monopolar terminal plate 705, a negative monopolar terminal plate 710, a plurality of bipolar plates 600 of the previous example and a plurality of separators 715. The bipolar plates 600 are stacked with a separator 715 placed between adjacent bipolar plates 600. The positive monopolar terminal plate 705 and the negative monopolar terminal plate 710 are placed at the two ends of said plurality of bipolar plates 600 with a separator 715 between the monopolar terminal plate and the next bipolar plate 600. Optionally, a pair of compression elements 720 and 725 may be present to compress the bipolar plate stack assembly 700.

### EXAMPLE 8

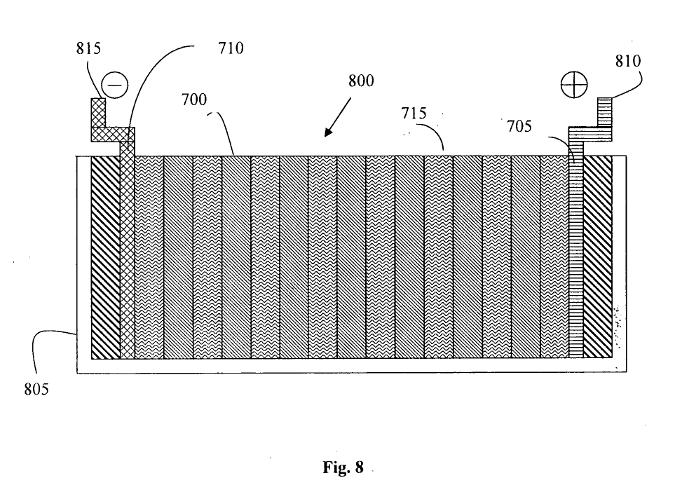

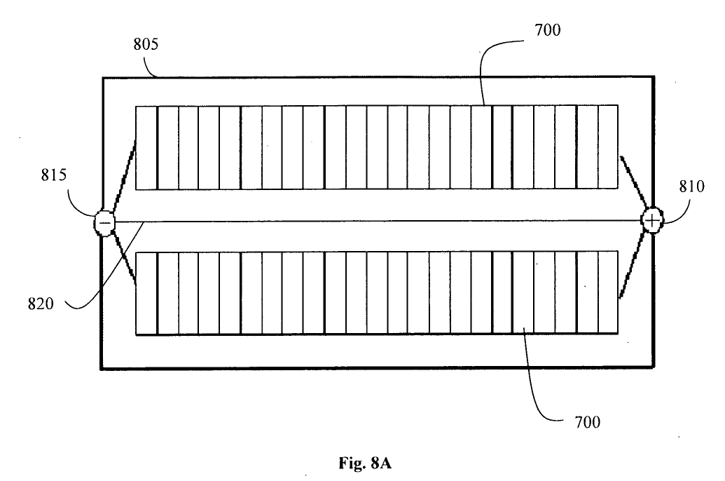

FIG. 8 provides an illustration of a lead acid battery 800 comprising one or more bipolar plate stack assembly of FIG. 7.

The figure illustrates a lead acid battery 800 comprising a container 805 having a positive terminal 810 and a negative terminal 815 and one or more bipolar plate stack assembly 700 of the previous embodiment. The bipolar plate stack assemblies 700 are arranged such that the positive monopolar terminal plates 705 of the bipolar plate stack assemblies 700 present in the lead acid battery 800 are electrically connected to the positive terminal 810. Similarly the negative monopolar terminal plates 710 are electrically connected to the negative terminal 815.

FIG. 8A provides an illustration a top view of a lead acid battery 800 comprising one or more bipolar plate stack assembly 700.

The figure illustrates a lead acid battery 800 with two bipolar plate stack assemblies 700. The two bipolar plate stack assemblies 700 are separated by container partitions 820 which are made of the same material as the container 805 or any other acid resistant, acid impervious and non conductive material.

While the invention has been particularly shown and described with reference to the embodiments above, it will be understood by those skilled in the art that various changes in form and detail may be made therein without departing from the spirit and scope of the invention.

1-9. (canceled)

10. A bipolar plate, comprising:
a grid having a first predetermined dimension;
a spacer having a second predetermined dimension;
a positive paste;
a negative paste;
a positive conducting surface; and
a negative conducting surface,
wherein said grid is folded over said spacer such that said grid covers substantially both sides of said spacer, said positive conducting surface being formed by pasting said positive paste on one side of said grid, and said negative conducting surface is formed by pasting said negative paste on another side of said grid.

11. The bipolar plate of claim 10, wherein said grid is a wire mesh.

12. The bipolar plate of claim 10, wherein said grid is made of a metallic material alloy.

13. The bipolar plate of claim 10, said bipolar plate being part of a lead acid battery.

14. A bipolar plate stack assembly, comprising:
a positive monopolar terminal plate;
a negative monopolar terminal plate;
a plurality of bipolar plates 600, said bipolar plate including:
a grid having a first predetermined dimension,
a spacer having a second predetermined dimension,
a positive paste,
a negative paste,
a positive conducting surface, and
a negative conducting surface,
wherein said grid is folded over said spacer such that said grid substantially covers both sides of said spacer, said positive conducting surface being formed by pasting said positive paste on one side of said grid, said negative conducting surface being formed by pasting said negative paste on another side of said grid; and a plurality of separators,
said plurality of bipolar plates being stacked with one of the separators placed between adjacent bipolar plates, and said positive monopolar terminal plate and said negative monopolar terminal plate being placed at the two ends of said plurality of bipolar plates with another one of the separators placed between a monopolar terminal plate and an adjacent bipolar plate.

15. A bipolar plate comprising:
a first grid having a first predetermined dimension;
a second grid having the first predetermined dimension;
a spacer having a second predetermined dimension;
a positive paste;
a negative paste;
a positive conducting surface; and
a negative conducting surface
wherein said first grid and said second grid are placed on either side of said spacer and connected along the edges of said first grid and said second grid such that said spacer is within said first grid and said second grid and said positive conductive surface is formed by pasting said positive paste over said first grid, and said negative surface is formed by pasting said negative paste over said second grid.

16. The bipolar plate of claim 15 wherein said first grid and said second grid are made of different materials.

17. The bipolar plate of claim 15, wherein said grid is a wire mesh.

18. The bipolar plate of claim 15, wherein said grid is made of a metallic material alloy.

19. The bipolar plate of claim 15, said bipolar plate being part of a lead acid battery.

20. A bipolar plate stack assembly comprising:
a positive monopolar terminal plate;
a negative monopolar terminal plate;
a plurality of bipolar plates, each bipolar plate including:
a first grid having a first predetermined dimension,
a second grid having the first predetermined dimension,
a spacer having a second predetermined dimension,
a positive paste,
a negative paste,
a positive conducting surface, and
a negative conducting surface,
wherein said first grid and said second grid are placed on either side of said spacer and connected along the edges of said first grid and said second grid such that said spacer is within said edges of said first grid and said second grid and said positive conductive surface is formed by pasting said positive paste over first grid and said negative surface is formed by pasting said negative paste over said second grid; and
a plurality of separators such that said plurality of bipolar plates are stacked with a separator placed between adjacent bipolar plates, and said positive monopolar terminal plate and said negative monopolar terminal plate are placed at the two ends of said plurality of bipolar plates with a separator between a monopolar terminal plate and an adjacent bipolar plate.

21. A lead acid battery, comprising:
a battery container including a positive terminal, a negative terminal, and one or more bipolar plate stack assembly, each bipolar stack assembly including:
a positive monopolar terminal plate,
a negative monopolar terminal plate, and
a plurality of bipolar plates, said bipolar plate including:
a grid having a first predetermined dimension;
a spacer having a second predetermined dimension;
a positive paste;
a negative paste;
a positive conducting surface; and
a negative conducting surface,
wherein said grid is folded over said spacer such that said grid substantially covers both sides of said spacer, said positive conducting surface being formed by pasting said positive paste on one side of said grid, said negative conducting surface being formed by pasting said negative paste on another side of said grid; and
a plurality of separators, said plurality of bipolar plates being stacked with one of the separators placed between adjacent bipolar plates, and said positive monopolar terminal plate and said negative monopolar terminal plate being placed at the two ends of said plurality of bipolar plates with another one of the separators placed between a monopolar terminal plate and an adjacent bipolar plate,
further, wherein a positive monopolar terminal plate of each bipolar plate stack assembly, is electrically connected to said positive terminal and a negative monopolar terminal plate of each bipolar plate stack assembly is electrically connected to said negative terminal.

22. A lead acid battery comprising:
a battery container including a positive terminal, a negative terminal, and one or more bipolar plate stack assembly, each bipolar stack assembly including:
a positive monopolar terminal plate,
a negative monopolar terminal plate,
a plurality of bipolar plates, each bipolar plate including:
a first grid having a first predetermined dimension,
a second grid having the first predetermined dimension,
a spacer having a second predetermined dimension,
a positive paste,
a negative paste,
a positive conducting surface, and
a negative conducting surface,
wherein said first grid and said second grid are placed on either side of said spacer and connected along the edges of said first grid and said second grid such that said spacer is within said edges of said first grid and said second grid and said positive conductive surface is formed by pasting said positive paste over first grid and said negative surface is formed by pasting said negative paste over said second grid; and
a plurality of separators such that said plurality of bipolar plates are stacked with a separator placed between adjacent bipolar plates, and said positive monopolar terminal plate and said negative monopolar terminal plate are placed at the two ends of said plurality of bipolar plates with a separator between a monopolar terminal plate and an adjacent bipolar plate,
further, wherein a positive monopolar terminal plate of each bipolar plate stack assembly, is electrically connected to said positive terminal and a negative monopolar terminal plate of each bipolar plate stack assembly is electrically connected to said negative terminal.
